(19) United States
(12) Patent Application Publication
(10) Pub. No.: US 2015/0103535 A1
(43) Pub. Date: Apr. 16, 2015

(54) Air-Cooled and Moisture-Resistant LED Lamp and Bulb

(71) Applicant: Wen-Sung Hu, Tainan City (TW)

(72) Inventor: Wen-Sung Hu, Tainan City (TW)

(21) Appl. No.: 14/052,793

(22) Filed: Oct. 14, 2013

(51) Int. Cl. F21V 3/00; F21V 29/00

(52) U.S. Cl. CPC F21V 3/005; F21V 29/22
USPC 362/363

(57) ABSTRACT

An air-cooled and moisture-resistant LED bulb includes a bulb base, a bulb holder engaged to the bulb base, and a transparent shell. The transparent shell and the bulb holder internally define a chamber in which a heat sink and a luminosity module including a substrate and at least an LED are held. Ventholes are respectively provided in the transparent shell and the bulb holder for development of air inlets and air outlets, and more than one ventilatory through-hole is formed in the substrate and the heat sink. The ventilatory through-holes, the air inlets and the air outlets reach a stack effect which contributes to heat dissipation inside and outside of the heat sink based on air inflow and outflow. Moreover, each of the air inlets and outlets is provided with a porous waterproof fabric for a moisture-resistant effect.

### BACKGROUND OF THE INVENTION

1. Field of the Invention

The present invention relates to an LED lamp/bulb and, more particularly, to an air-cooled and moisture-resistant LED bulb.

2. Description of the Related Art

Cooling structures of LED bulbs which are main factors influencing light decay are being supplemented by various thermal conductivity and dissipation designs of manufacturers who try to remove most heat out of the LED bulbs.

FIGS. 1 through 5 illustrate conventional LED bulbs 1A, 1B, 1C, 1D and 1E, each of which includes ventholes 11 and/or convection holes 12 for cooling a heat sink 13 externally but still has drawbacks as follows:

1. There is no circulatory heat dissipation, e.g., cold air drawn due to rising warm air, but heat storage on cavity walls because of no convection of air inside a bulb cavity 14.

2. Heat out of LEDs 15 is conducted to a substrate 16 for heat dissipation through an outer end face of the substrate 16. However, heat on the outer end face of the substrate 16 is accumulated and stored while staying or lingering in a sealed shell cavity 171 of a transparent shell 17. The heat storage in the shell cavity 171 aggravates temperature sustained by the LEDs 15, deteriorating light decay.

3. Cold air still permeate the bulb cavity 14 through the ventholes 11 of a disabled conventional LED bulb in which some air paths 18 for heat dissipation are designed between the ventholes 11 and the cavity 14. Moreover, any exposed metal conductor or welding position of an electronic component, e.g., driver, inside a bulb/lamp may be oxidized by excessive gaseous moisture permeating the cavity 14, threatening the driver's service life. Thus, high-end LED bulbs (e.g., an LED bulb IF in FIG. 6) based on ventholes in their cooling structure are rare until now.

For an LED bulb compatible to a conventional lamp with an upward bulb adapter, for example, a floor lamp (FIG. 7), a desk lamp (FIG. 8), a wall lamp 7 (FIG. 9) or a landscaping light (FIG. 10), many manufacturers had shortened an LED bulb's overall length (see L1 in FIG. 11) and a heat sink's length (see L3 in FIG. 11), extended a transparent shell's length (see L2 in FIG. 11), and designed LEDs 15 as a light source higher than a bottom edge 19 of a transparent shell 17 (see FIG. 11). Two objectives to use the designs in the lamp with the upward bulb adapter are shown as follows:

1. A bulb's shortened overall length makes both direct light projected on the transparent shell or a reflector (see B1 in FIG. 12) and reflected light projected downward (see B2 in FIG. 12) occupy more regions.

2. Referring to FIG. 13, the LEDs 15 as a light source higher than the bottom edge of the transparent shell intensify halo, which is reflected from an inner edge of the transparent shell and directed toward lower left and lower right, increasing the transparent shell's angle of projection felt by eyes.

However, the holder of the substrate at which a light source at a higher position is located will be protrudent in the shell cavity 171 (see FIG. 11). The protruded surface area of the holder will aggravate temperature sustained by the shell cavity 171 and the activated LEDs 15, deteriorating light decay. Experimentally, temperature at a heat sink attributed to a light source at a higher position and a shrunk heat delivery area is increased by 12 to 15 degrees Celsius or more, which needs to be decreased by an alternative lamp structure based on other new materials for thermal conduction and cooling. Thus, the cost is increased, obstructing population of LED bulbs.

FIG. 14 illustrates a conventional LED lamp 2. The LED lamp 2 includes a lamp base 21 and a number of ventholes 22 formed in the lamp base 21. Each venthole 22 is covered with a porous waterproof fabric 23 which keeps moisture (moisture is heavier than air and deposited underneath) out of the LED lamp 2. However, heat generated by LEDs as a light source inside a sealed cavity 24 of the LED lamp 2 cannot be dissipated. Thus, a stack effect is failed because no air circulation inside the LED lamp 2 with the upward ventholes 22 for heat dissipation, but increased temperature sustained by the LEDs aggravates light decay.

Accordingly, how to design an LED bulb/lamp with air-cooled and moisture-resistant effects is an important issue studied by the persons skilled in the art.

### BRIEF SUMMARY OF THE INVENTION

Therefore, it is an objective of the present invention to overcome the aforementioned shortcoming and deficiency of the prior art by providing an air-cooled and moisture-resistant LED bulb. The LED bulb includes a bulb base, a bulb holder, a transparent shell, a heat sink, and a luminosity module. The bulb base includes a head end provided with a bulb adapter and an open end with an opening. The bulb holder is engaged to the open end of the bulb base. A plurality of first ventholes is provided in the bulb holder or the bulb base, and a porous waterproof fabric is externally or internally coated on each of the first ventholes. The transparent shell is engaged to the bulb holder, and the transparent shell and the bulb holder together define a chamber therein. The transparent shell includes a plurality of second ventholes therein, and a porous waterproof fabric is externally or internally coated on each of the second ventholes. The heat sink is received in the chamber or integrally formed with the bulb holder. The heat sink includes a cavity therein. The luminosity module is held in the chamber and includes a substrate mounted on the heat sink and a number of LEDs mounted on the substrate. At least one ventilatory through-hole is formed in the substrate and in communication with the cavity in the heat sink. A stack effect is completed with the cavity in the heat sink, the ventilatory through-hole in the substrate, and the first and second ventholes, all of which contribute to heat dissipation inside and outside of the heat sink based on air inflow and outflow.

In another embodiment, an air-cooled and moisture-resistant LED lamp is provided and includes a lamp holder, a transparent shell, a heat sink, and a luminosity module. At least one driver is received in the lamp holder, and at least one first venthole is provided in the lamp holder. At least one porous waterproof fabric is externally or internally coated on the at least one first venthole. The transparent shell is engaged to the lamp holder, and the transparent shell and the lamp holder together define a chamber therein. The transparent shell includes at least one second venthole therein, and at least one porous waterproof fabric is externally or internally coated on the at least one second venthole. The heat sink is received in the chamber or integrally formed with the lamp holder, and the heat sink includes a cavity therein. The luminosity module is held in the chamber and electrically connected to the driver, and the luminosity module includes a substrate mounted on the heat sink and at least one LED mounted on the substrate. At least one ventilatory through-hole is formed in the substrate and in communication with the cavity in the heat sink. The cavity in the heat sink, the ventilatory through-hole in the substrate, and the first and second ventholes reach a stack effect, allowing heat dissipation inside and outside of the heat sink based on air inflow and outflow.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIGS. 1 through 6 are schematic views illustrating six conventional LED bulbs.

FIGS. 7 through 10 are schematic views illustrating a conventional floor lamp, a conventional desk lamp, a conventional wall lamp, and a conventional landscaping light.

FIG. 11 is a schematic view illustrating a conventional LED bulb with an upward bulb adapter.

FIG. 12 is a schematic view illustrating more areas covered by light downward reflected due to a shrunk length of the LED bulb in FIG. 11.

FIG. 13 is a schematic view illustrating more areas covered by light downward reflected due to the LED bulb in FIG. 11 as a light source at a higher position.

FIG. 14 is a schematic view illustrating another conventional LED lamp.

FIG. 15 is a cross sectional view of a LED bulb according to a first embodiment of the present invention.

FIG. 16 is a schematic view illustrating ventilation and heat dissipation of the LED bulb of FIG. 15.

FIG. 17 is a cross sectional view of a LED bulb according to a second embodiment of the present invention used in a lamp positioned horizontally.

FIG. 18 is a cross sectional view of a LED bulb according to a third embodiment of the present invention.

FIG. 19 is a cross sectional view of a LED bulb according to a fourth embodiment of the present invention.

FIGS. 20 and 21 are cross sectional views illustrating two LED bulbs of the present invention used in a lamp positioned horizontally.

FIGS. 22 and 23 are schematic views illustrating two LED bulbs of the present invention used in a lamp projecting light downward.

FIG. 24 is a cross sectional view of a LED lamp according to a first embodiment of the present invention used in a streetlight.

FIG. 24a is a side view of the LED lamp of FIG. 24.

FIG. 25 is a cross sectional view of a LED lamp according to a second embodiment of the present invention used in a streetlight.

FIG. 25a is a side view of the LED lamp of FIG. 25.

FIG. 26 is a schematic view similar to FIG. 15, with a porous waterproof fabric internally covered on each of the first and second ventholes.

FIG. 26a is a schematic view similar to FIG. 26, with first ventholes provided in a bulb base of the LED bulb.

FIG. 27 is a schematic view similar to FIG. 24, with a plurality of cooling fins provided on a top hood of a lamp holder of the LED lamp.

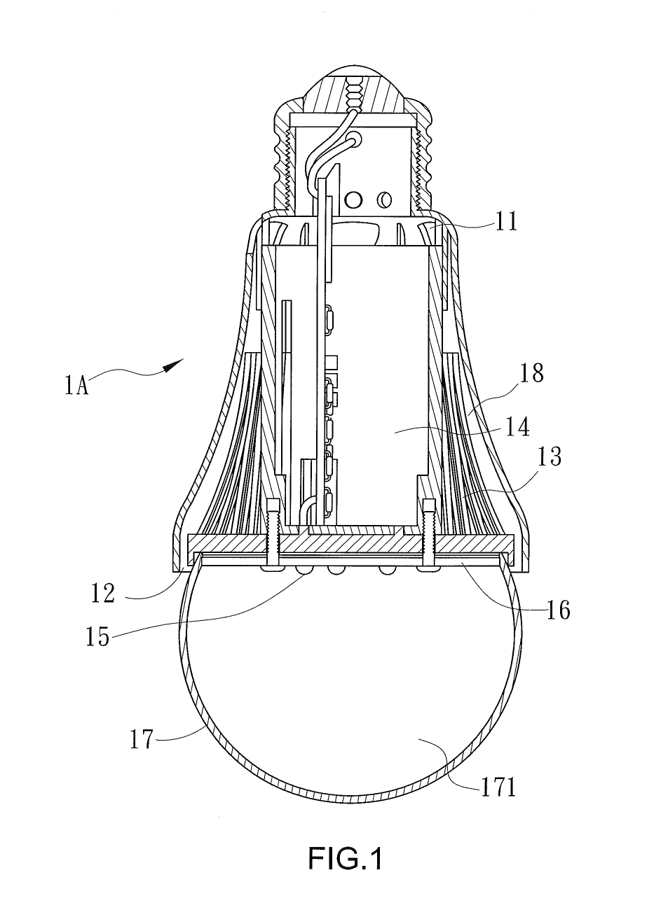

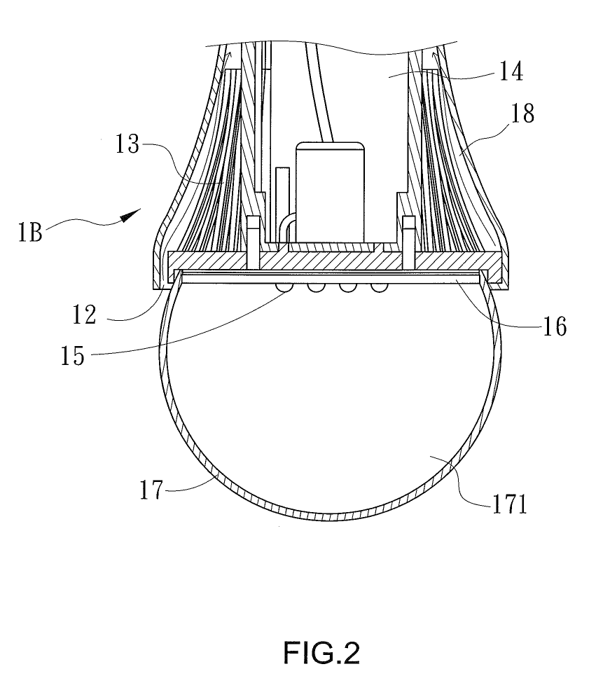

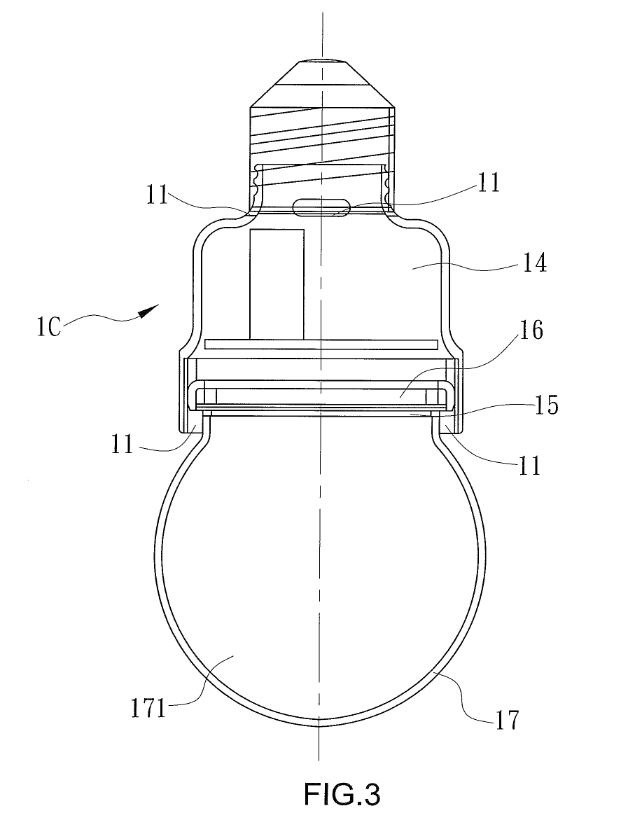

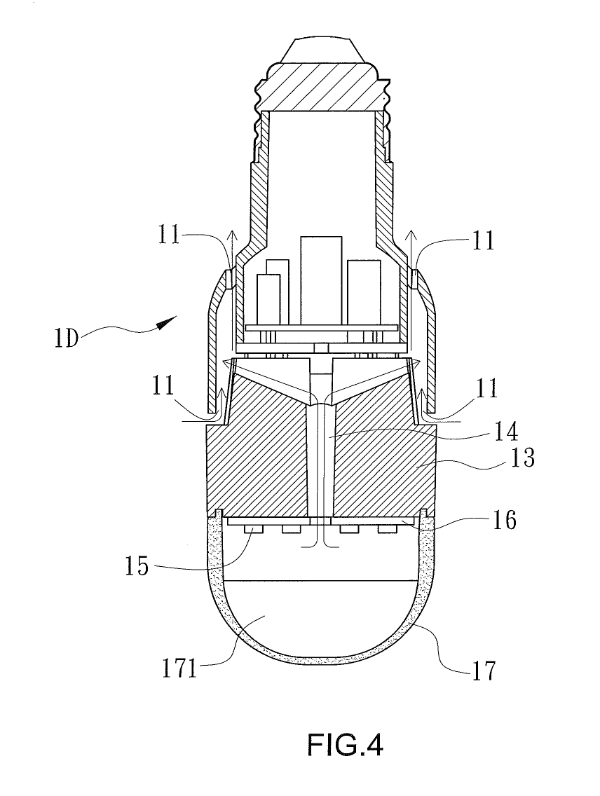

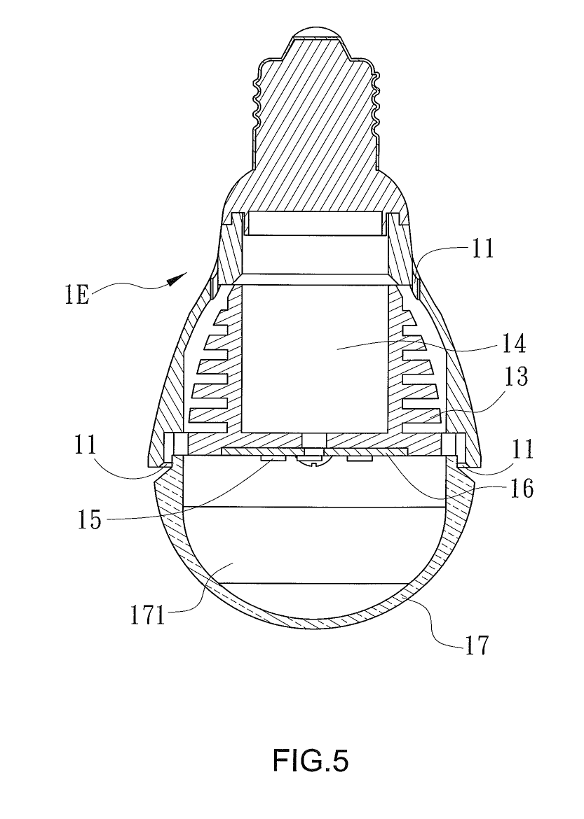

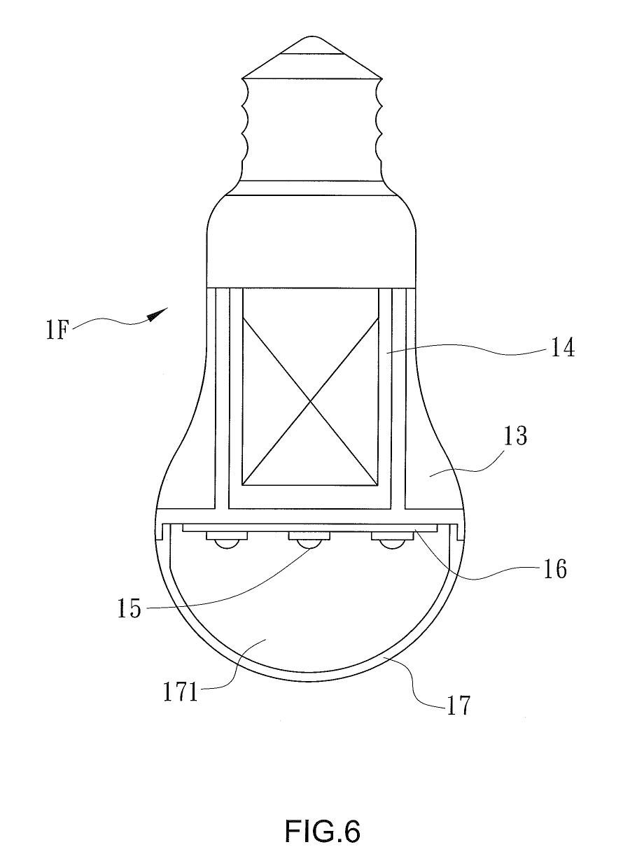

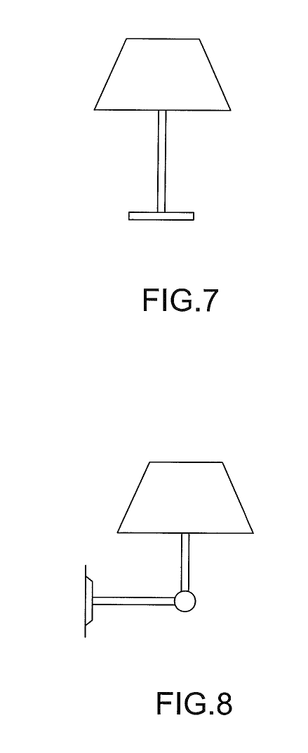

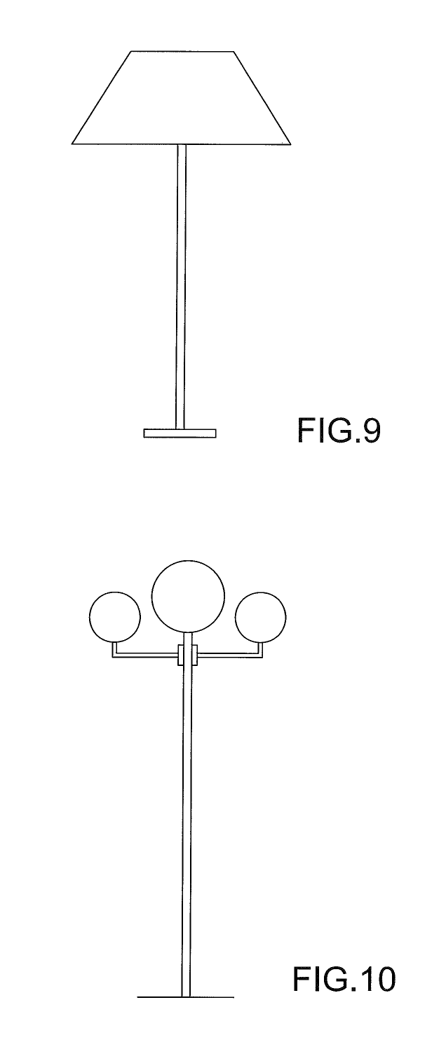

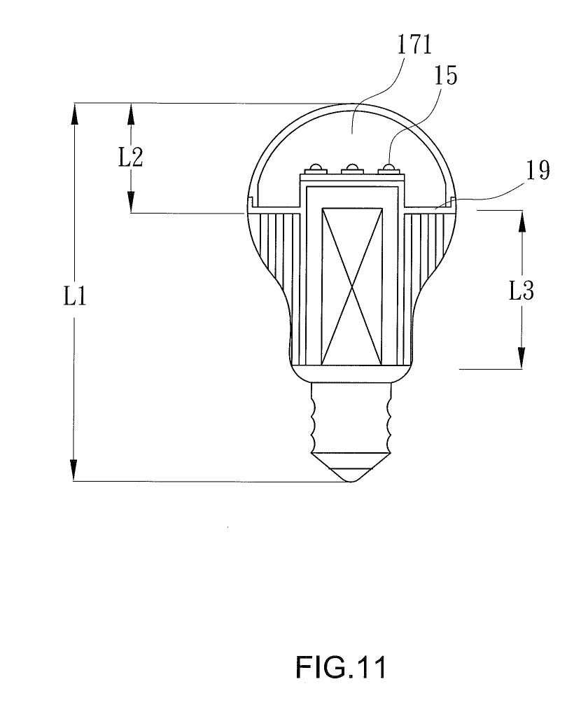

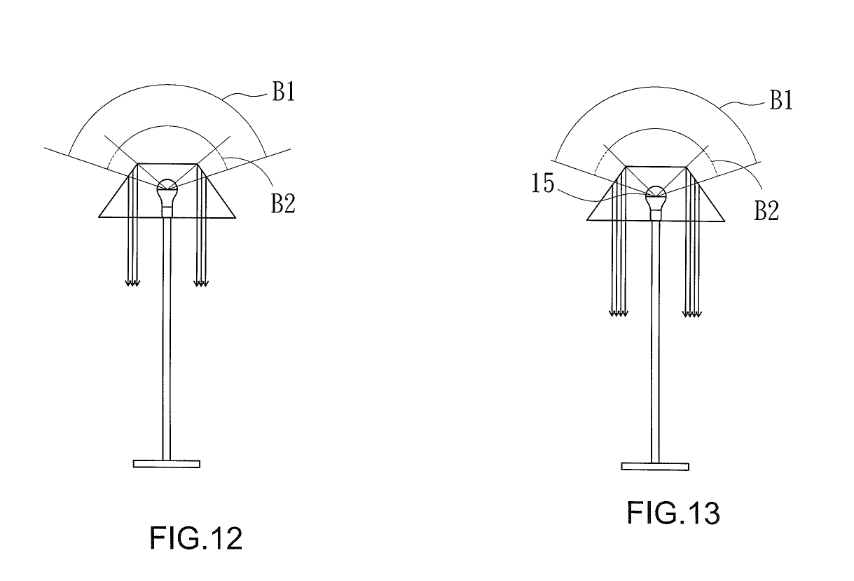

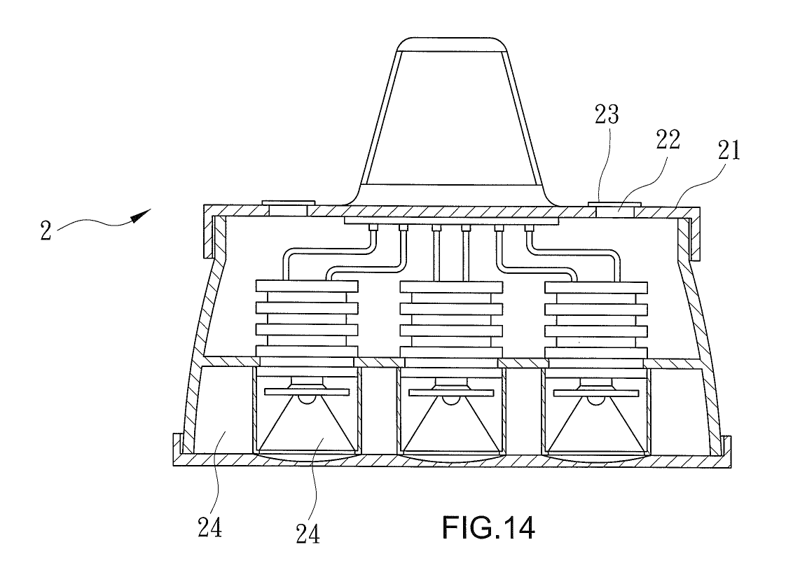

### DETAILED DESCRIPTION OF THE INVENTION

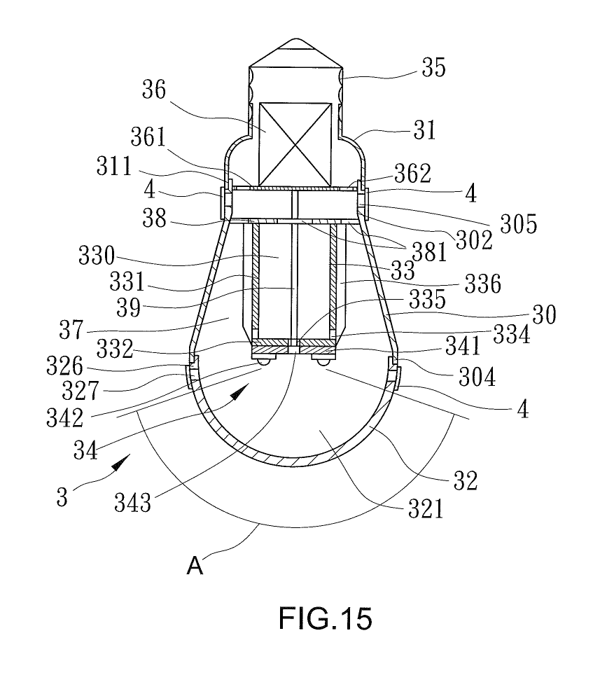

An air-cooled and moisture-resistant LED bulb of a first embodiment of the present invention is shown in FIG. 15 of the drawings and generally designated 3. In this embodiment, the LED bulb 3 includes a bulb base 31, a bulb holder 30, a transparent shell 32, a heat sink 33, and a luminosity module 34.

A bulb adapter 35 is mounted on a head end (a top end in FIG. 15) of the bulb base 31, and a driver 36 is provided in the bulb base 31 and located below the bulb adapter 35. The driver 36 is installed on a printed circuit board (PCB) 361 which is held in the bulb base 31 and includes a plurality of air vents 362 therein. The bulb base 31 includes an open end 311 with an opening.

The bulb holder 30 is in the form of a tapered cylinder and includes a first end 302 with an upper opening and a second end 304 with a lower opening. The first end 302 of the bulb holder 30 is engaged with the open end 311 of the bulb base 31 and includes a plurality of first ventholes 305 spaced from each other in a circumferential direction of the first end 302. A support member 38 is mounted in the bulb holder 30 to fix the heat sink 33. In this embodiment, the support member 38 is held in the first end 302 of the bulb holder 30 and includes at least one ventilatory through-hole 381 respectively in a center and a periphery thereof. The ventilatory through-holes 381 are in communication with the air vents 362 in the printed circuit board 361. In this embodiment, the bulb holder 30 and the bulb base 31 are two components which are separated from each other, and the bulb holder 30 can be transparent or opaque. The first ventholes 305 are located between the printed circuit board 361 and the support member 38 in a longitudinal direction (vertical direction) of the bulb holder 30. However, the bulb holder 30 and the bulb base 31 can be integrally formed as a single, monolithic component.

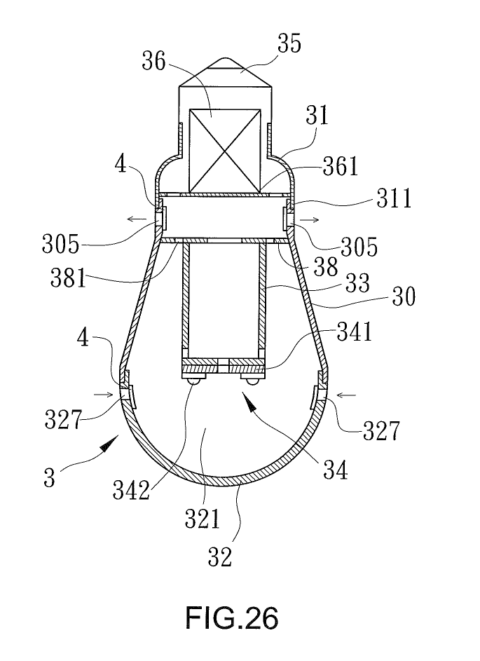

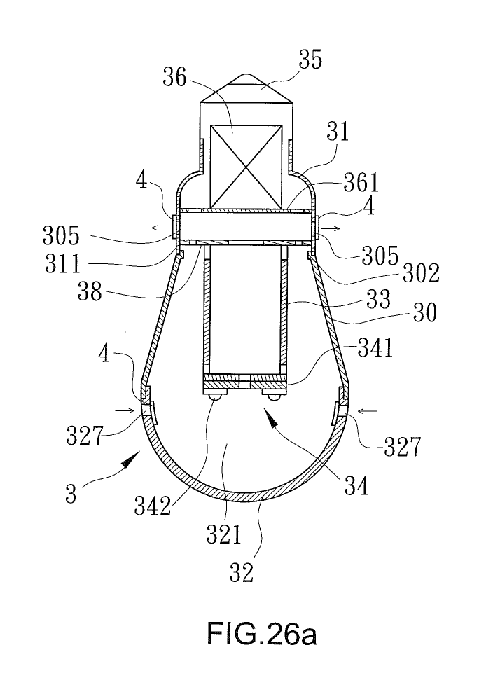

The transparent shell 32 is engaged to the second end 304 of the bulb holder 30 and coordinates with the bulb holder 30 and the bulb base 31 to collectively define a chamber 37. In this embodiment, the transparent shell 32 is hemispheric in shape and includes a joining end 326 with an opening. The joining end 326 is coupled to the second end 304 of the bulb holder 30, and a shell cavity 321 is defined inside the transparent shell 32. Furthermore, the joining end 326 is provided with a plurality of second ventholes 327 spaced from each other in a circumferential direction thereof. In this embodiment, each of the first and second ventholes 305 and 327 is externally coated or covered with a porous waterproof fabric 4. Referring to FIG. 26, in another embodiment, each of the first and second ventholes 305 and 327 is internally coated with the porous waterproof fabric 4. Further, In a feasible embodiment, the first ventholes 305 are formed around the bulb base 31 and adjacent to the first end 302 of the bulb holder 30 (see FIG. 26a), that is, the open end 311 of the bulb base 31 is extended, and the first ventholes 305 are provided in the open end 311 of the bulb base 31 and located between the printed circuit board 361 and the support member 38.

The heat sink 33 is received in the chamber 37 and has U-shaped cross sections. In this embodiment, the heat sink 33 includes a bottom wall 332 and an annular side wall 331 in which a cavity 330 is defined. An upper end of the heat sink 33 is in communication with the ventilatory through-holes 381 in the support member 38. A plurality of ventilatory through-holes 334 is provided in a lower portion of the side wall 331 and spaced from each other in a circumferential direction of the side wall 331. A ventilatory through-hole 335 is provided in a center of the bottom wall 332. The heat sink 33 includes cooling fins 336 on an outer periphery thereof.

The luminosity module 34 is held in the chamber 37 and includes a substrate 341 mounted on the bottom wall 332 of the heat sink 33 and a number of LEDs (SMDs/chips) 342 mounted on the substrate 341. In this embodiment, the LEDs 342 is located between the first ventholes 305 and the second ventholes 327 in the longitudinal direction and located above the joining end 326 of the transparent shell 32, so that the second ventholes 327 of the transparent shell 32 is lower than the LEDs 342 in the longitudinal direction and beyond a beam angle (A) of the LEDs 342, for example 140 degrees. A ventilatory through-hole 343 is formed in the substrate 341 and in communication with the ventilatory through-hole 335 in the bottom wall 332. Heat generated by the LEDs 342 can be dissipated in outside air through the substrate 341 and the heat sink 33. The luminosity module 34 is electrically connected to the driver 36 through an electric circuit 39, so that the LEDs 342 can be driven to project light beams toward the transparent shell 32.

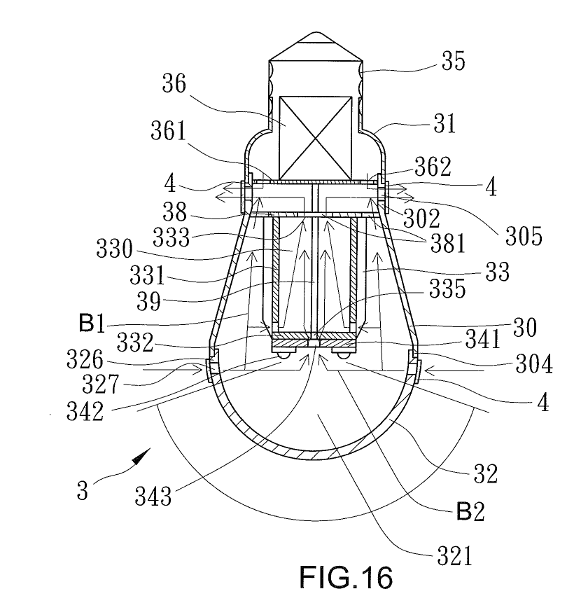

In the embodiment of FIG. 15, the first ventholes 305 and the second ventholes 327 develop air outlets and air inlets, respectively. FIG. 16 is a schematic view illustrating heat dissipation of the LED bulb 3 in which a stack effect is completed with heat out of the LEDs 342 dissipated through exterior and interior of the heat sink 33. That is, heat from the LEDs 342 is dissipated outward through the substrate 341, the cooling fins 336 of the heat sink 33, the ventilatory through-holes 381 in the support member 38 and the first ventholes 305, and cold air is introduced from the second ventholes 327 for completion of a stack effect (see arrow B1 in FIG. 16). In addition, heat out of the LEDs 342 is also dissipated through the ventilatory through-hole 343 in the substrate 341, the ventilatory through-hole 335 in the bottom wall 332, the cavity 330 in the heat sink 33, the central ventilatory through-holes 381 in the support member 38 and the first ventholes 305 for completion of a stack effect, with cold air introduced from the second ventholes 327 (see arrow B2 in FIG. 16). The porous waterproof fabrics 4 covered over the first and second ventholes 305 and 327 are intended to resist moisture air and protect the LEDs 342 as well as the driver 36 from moisture-induced oxidation when the LED bulb 3 is disabled.

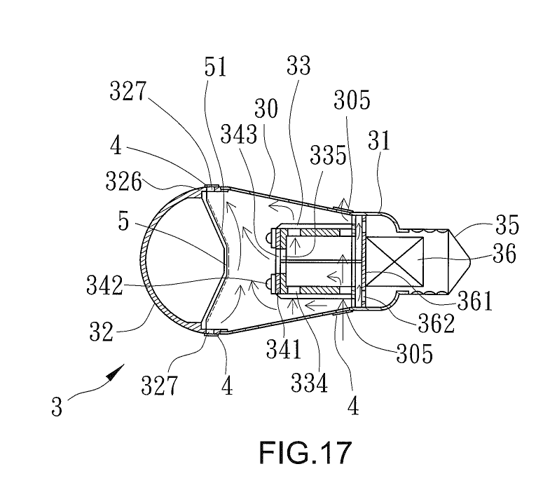

FIG. 17 illustrates a LED bulb 3 of a second embodiment of the present invention modified from the first embodiment, with the LED bulb 3 positioned horizontally. In the embodiment, a reflector 5 is held in the joining end 326 of the transparent shell 32 and provided with a layer of reflective film 51 at one side thereof facing the luminosity module 34 for development of downward projected light based on reflection of light which is projected toward the transparent shell 32 by the LEDs 342. In the embodiment of FIG. 17, the LEDs 342 are arranged between the first ventholes 305 and the second ventholes 327 in the longitudinal direction of the bulb holder 30, with a lower first venthole 305 and a lower second venthole 327 acting as air inlets and with an upper first venthole 305 and an upper second venthole 327 acting as air outlets. As such, a stack effect is completed with the ventilatory through-hole 343 in the substrate 341, the ventilatory through-hole 335 in the bottom wall 332, the cavity 330 in the heat sink 33, the ventilatory through-holes 381 in the support member 38, and the first and second ventholes 305 and 327, all of which contribute to heat dissipation based on air inflow and outflow.

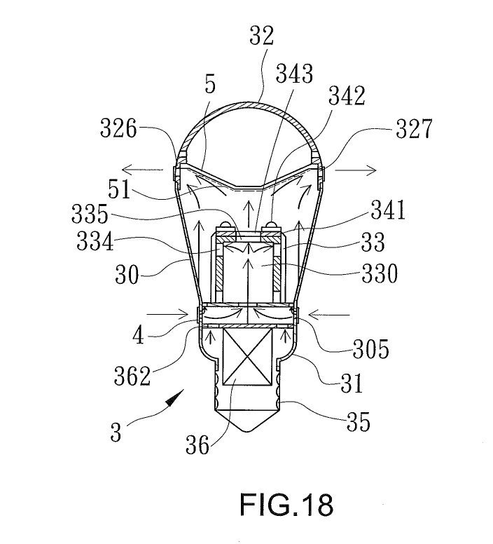

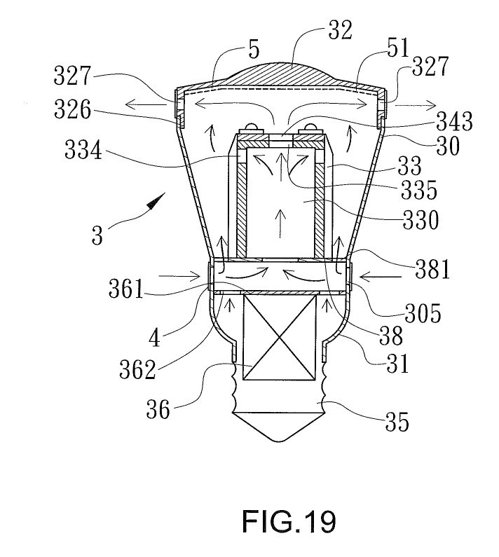

FIGS. 18 and 19 illustrate LED bulbs 3 of third and fourth embodiments of the present invention modified from the second embodiment, with each of the LED bulbs 3 having an upward bulb adapter 35. In each embodiment, a reflector 5 is held in the transparent shell 32, and the LEDs 342 are arranged between the first ventholes 305 and the second ventholes 327 in the longitudinal direction of the bulb holder 30, with lower first ventholes 305 acting as air inlets and with upper second ventholes 327 acting as air outlets. As such, a stack effect is completed with the ventilatory through-hole 343 in the substrate 341, the ventilatory through-hole 335 in the bottom wall 332, the cavity 330 in the heat sink 33, the ventilatory through-holes 381 in the support member 38, and the first and second ventholes 305 and 327, all of which contribute to heat dissipation based on air inflow and outflow.

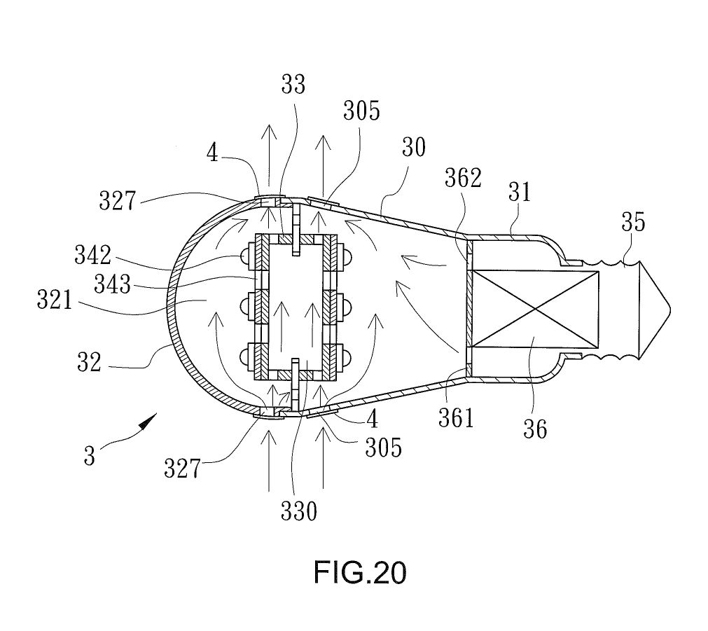

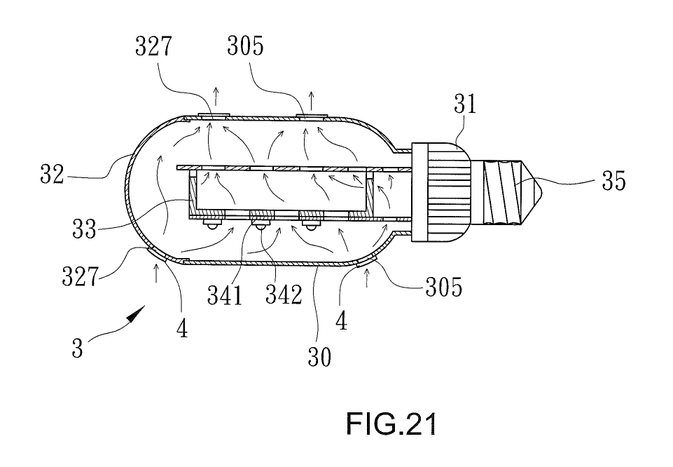

FIGS. 20 and 21 illustrate LED bulbs 3 of fifth and six embodiments of the present invention, with the LED bulbs 3 positioned horizontally. Referring to FIG. 20, the LED bulb 3 includes two units of luminosity modules 34. Similarly, a stack effect is completed with the ventilatory through-holes 343 in the substrate 341, the cavity 330 in the heat sink 33, the ventilatory through-holes 381 in the support member 38, and the first and second ventholes 305 and 327, all of which contribute to heat dissipation based on air inflow and outflow.

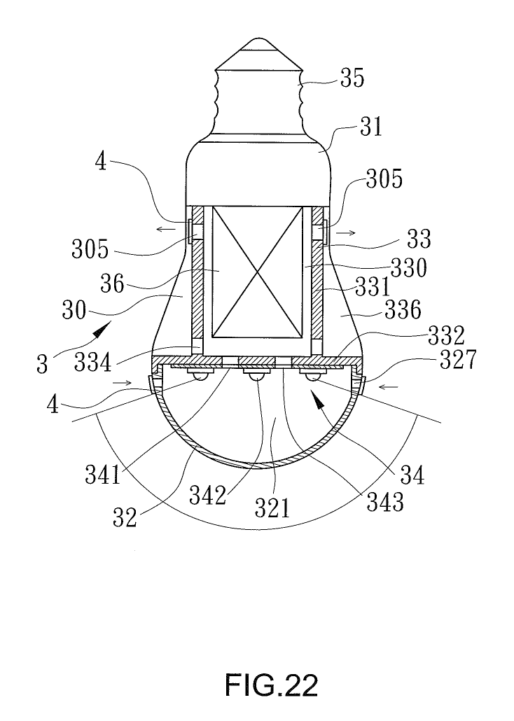

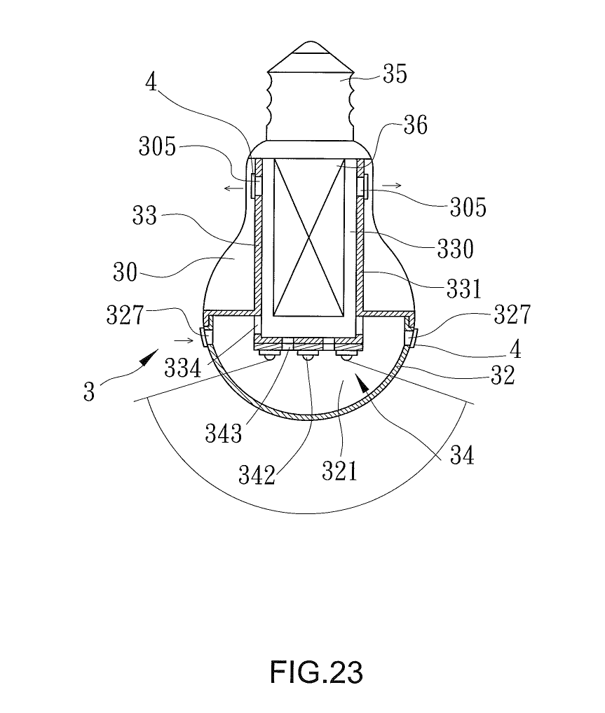

FIGS. 22 and 23 illustrate two LED bulbs 3 of the present invention used in bulbs projecting light downward. In the embodiments, the bulb holder 30 and the heat sink 33 are integrally formed as a single, monolithic component. The bulb holder 30 is made from material for cooling and externally provided with the cooling fins 336. The first ventholes 305 are provided in the side wall 331 of the heat sink 33 and in communication with the cavity 330 of the heat sink 33, the second ventholes 327 are provided in the transparent shell 32, and the first and second ventholes 305 and 327 are externally covered with the porous waterproof fabric 4. Similarly, a stack effect is completed with the ventilatory through-holes 343 in the substrate 341, the ventilatory through-holes 334 in the heat sink 33, the cavity 330 in the heat sink 33, and the first and second ventholes 305 and 327, all of which contribute to heat dissipation based on air inflow and outflow.

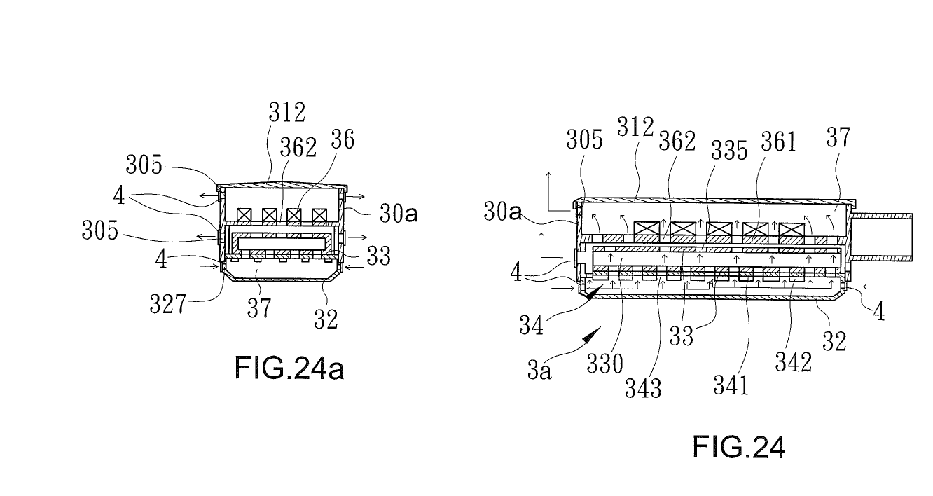

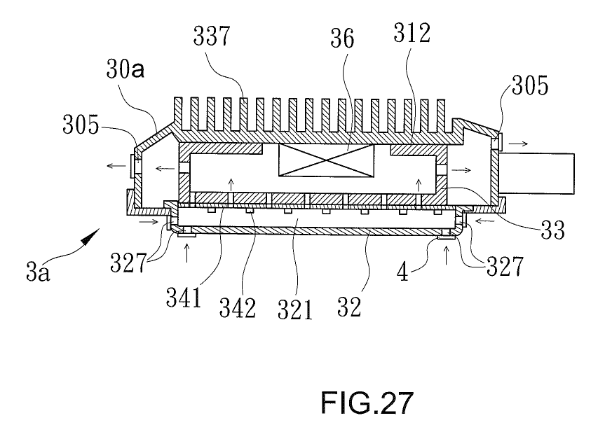

An air-cooled and moisture-resistant LED lamp of the present invention is shown in FIGS. 24 and 24a of the drawings and generally designated 3a. In this embodiment, the LED lamp 3 is used in a streetlight and includes a lamp holder 30a, a transparent shell 32, a heat sink 33, and a luminosity module 34. A top hood 312 is provided on an upper end of the lamp holder 30a, and a plurality of drivers 36 is provided in the lamp holder 30a and installed on a printed circuit board 361 in which a plurality of air vents 362 are opened. A plurality of first ventholes 305 is provided in side walls of the lamp holder 30a, and each of the first ventholes 305 is externally coated or covered with a porous waterproof fabric 4. The transparent shell 32 is engaged to the lamp holder 30a to collectively define a chamber 37 therein. The transparent shell 32 is provided with a plurality of second ventholes 327 therein. The heat sink 33 is held in the chamber 37 or integrally formed with the lamp holder 30a to become a single, monolithic component. The upper first ventholes 305 constitute air outlets (air outlets situated in the side wall of the lamp holder 30a can prevent the porous waterproof fabric 4 from obstruction attributed to dust or rain), and the lower second ventholes 327 constitute air inlets. As such, a stack effect is completed with the ventilatory through-hole 343 in the substrate 341, the cavity 330 in the heat sink 33, the air vents 362 in the printed circuit board 361, and the first and second ventholes 305 and 327, all of which contribute to heat dissipation based on air inflow and outflow. In a feasible embodiment, the lamp holder 30a or the top hood 312 is made from material for cooling and includes a plurality of cooling fins 337 (FIG. 27). In FIG. 27, the heat sink 33 abuts the lamp holder 30a.

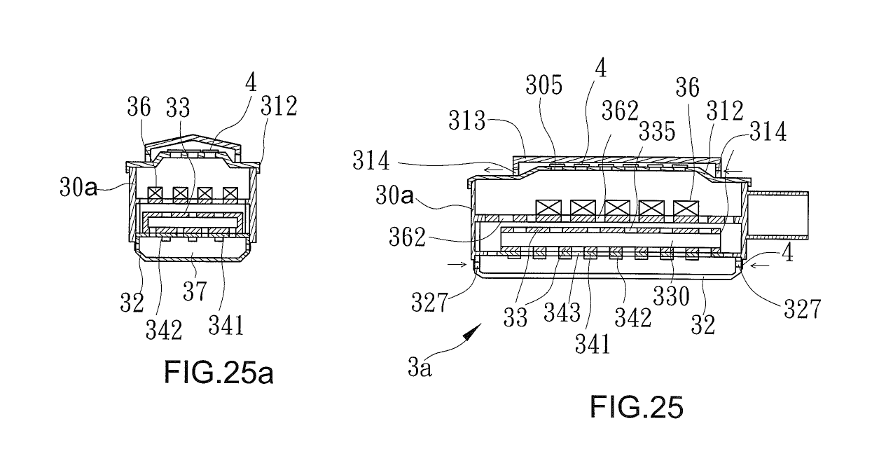

FIGS. 25 and 25a illustrate a LED lamp 3a of a second embodiment of the present invention used in a streetlight. In this embodiment, the LED lamp 3a includes a lamp holder 30a, a transparent shell 32, a heat sink 33, and a luminosity module 34. A plurality of drivers 36 is provided in the lamp holder 30a and installed on a printed circuit board 361 in which a plurality of air vents 362 are provided. Furthermore, a top hood 312 is provided on an upper end of the lamp holder 30a, and a plurality of first ventholes 305 is provided in the top hood 312. The transparent shell 32 is engaged to the lamp holder 30a and provided with a plurality of second ventholes 327. Each of the first and second ventholes 305 and 327 is externally coated or covered with a porous waterproof fabric 4. The upper first ventholes 305 and the lower second ventholes 327 constitute air outlets and air inlets, respectively. As such, a stack effect is completed with the ventilatory through-hole 343 in the substrate 341, the cavity 330 in the heat sink 33, the air vents 362 in the printed circuit board 361, and the first and second ventholes 305 and 327, all of which contribute to heat dissipation based on air inflow and outflow. Moreover, a top of the top hood 312 is provided with a convection piece 313, preventing the porous waterproof fabrics 4 from obstruction attributed to dust or rain. Furthermore, the convection piece 313 is provided with convection holes 314 in both sides thereof for dissipation of heat guided from the first ventholes 305. In a feasible embodiment, the lamp holder 30a, the top hood 312 or the convection piece 313 is made from material for cooling and includes a plurality of cooling fins.

Although specific embodiments have been illustrated and described, numerous modifications and variations are still possible without departing from the essence of the invention. The scope of the invention is limited by the accompanying claims.

1. An air-cooled and moisture-resistant LED bulb comprising:
a bulb base including a head end provided with a bulb adapter and an open end with an opening;
a bulb holder engaged to the open end of the bulb base, with a plurality of first ventholes provided in the bulb holder or the bulb base, with a porous waterproof fabric externally or internally covered on each of the first ventholes;
a transparent shell engaged to the bulb holder, with the transparent shell and the bulb holder together defining a chamber therein, with the transparent shell including a plurality of second ventholes therein, with a porous waterproof fabric externally or internally covered on each of the second ventholes;
a heat sink received in the chamber or integrally formed with the bulb holder, with the heat sink including a cavity therein; and
a luminosity module held in the chamber and including a substrate mounted on the heat sink and a number of LEDs mounted on the substrate, with at least one ventilatory through-hole formed in the substrate and in communication with the cavity in the heat sink,
wherein the cavity in the heat sink, the ventilatory through-hole in the substrate, and the first and second ventholes reach a stack effect, allowing heat dissipation inside and outside of the heat sink based on air inflow and outflow.

2. The LED bulb according to claim 1, wherein the bulb holder includes a first end with an upper opening and a second end with a lower opening, with the first end of the bulb holder engaged to the open end of the bulb base, with the first ventholes formed in the first end of the bulb holder, with the transparent shell including a joining end coupled to the second end of the bulb holder, with the second ventholes formed in the joining end of the transparent shell.

3. The LED bulb according to claim 2, wherein the bulb holder is transparent or opaque, with the bulb holder and the bulb base being integrally formed as a single, monolithic component.

4. The LED bulb according to claim 2, wherein the bulb holder is made from material for cooling and externally provided with the cooling fins.

5. The LED bulb according to claim 1, wherein a driver is provided in the bulb base and installed on a printed circuit board held in the bulb base, with the printed circuit board including a plurality of air vents therein, with the luminosity module electrically connected to the driver, with the heat sink including a bottom wall and an annular side wall in which the cavity is defined, with a ventilatory through-hole provided in the bottom wall, with a plurality of ventilatory through-holes provided in a lower portion of the side wall and in communication with the air vents in the printed circuit board, with a support member mounted in the bulb holder, with the heat sink mounted to the support member, with the first ventholes located between the printed circuit board and the support member in a longitudinal direction of the bulb holder.

6. An air-cooled and moisture-resistant LED lamp, comprising:
a lamp holder, with at least one driver received in the lamp holder, with at least one first venthole provided in the lamp holder, with at least one porous waterproof fabric externally or internally covered on the at least one first venthole;
a transparent shell engaged to the lamp holder, with the transparent shell and the lamp holder together defining a chamber therein, with the transparent shell including at least one second venthole therein, with at least one porous waterproof fabric externally or internally covered on the at least one second venthole;
a heat sink received in the chamber or integrally formed with the lamp holder, with the heat sink including a cavity therein; and
a luminosity module held in the chamber and electrically connected to the driver, with the luminosity module including a substrate mounted on the heat sink and at least one LED mounted on the substrate, with at least one ventilatory through-hole formed in the substrate and in communication with the cavity in the heat sink,
wherein the cavity in the heat sink, the ventilatory through-hole in the substrate, and the first and second ventholes reach a stack effect, allowing heat dissipation inside and outside of the heat sink based on air inflow and outflow.

7. The LED lamp according to claim 6, wherein a plurality of first ventholes is provided in the lamp holder and constitute air outlets, with a plurality of second ventholes provided in the transparent shell and constituting air inlets, with the at least one driver installed on a printed circuit board having a plurality of air vents, wherein the air vents in the printed circuit board, the cavity in the heat sink, the ventilatory through-hole in the substrate, and the first and second ventholes reach a stack effect, allowing heat dissipation inside and outside of the heat sink based on air inflow and outflow.

8. The LED lamp according to claim 6, wherein the lamp holder includes a top hood provided on an upper end thereof, with the at least one first venthole provided in the top hood, with the at least one driver installed on a printed circuit board having a plurality of air vents, wherein the air vents in the printed circuit board, the cavity in the heat sink, the ventilatory through-hole in the substrate, and the first and second ventholes reach a stack effect, allowing heat dissipation inside and outside of the heat sink based on air inflow and outflow.

9. The LED lamp according to claim 8, wherein a plurality of first ventholes is provided in the top hood and constitute air outlets, with a plurality of second ventholes provided in the transparent shell and constituting air inlets, with the lamp holder or the top hood being made from material for cooling and provided with cooling fins.

10. The LED lamp according to claim 8, wherein the top hood includes a convection piece on a top of the top hood, with the convection piece including convection holes in both sides thereof for dissipation of heat guided from the first ventholes, with the lamp holder, the top hood or the convection piece being made from material for cooling and provided with cooling fins.
